(19) United States
(12) Patent Application Publication
(10) Pub. No.: US 2015/0181000 A1
(43) Pub. Date: Jun. 25, 2015

(54) METHOD AND APPARATUS FOR SIGNALING LOAD MANAGEMENT

(71) Applicants: Silke Holtmanns, Klaukkala (FI); Seamus Moloney, Riihimaki (FI)

(72) Inventors: Silke Holtmanns, Klaukkala (FI); Seamus Moloney, Riihimaki (FI)

(21) Appl. No.: 14/403,643

(22) PCT Filed: May 31, 2012
(86) PCT No.: PCT/IB2012/052759

§ 371 Date: Nov. 25, 2014

(51) Int. Cl. H04L 29/08; H04W 28/02; H04W 76/02

(52) U.S. Cl. CPC H04L 67/325; H04W 76/02; H04W 28/0289

(57) ABSTRACT

Methods, apparatuses, and computer program products herein enable a communication device to enable the bundling of one or more connection requests in order to reduce overall signaling from a communication device. An example method may include receiving a connection request from an application. In some example embodiments, the connection request defines a connection time indication. The method may further include receiving at least one additional connection request from one or more applications. The method may further include determining a connection time for the application and the one or more applications. In some example embodiments, the connection time is configured to enable the application and the one or more applications to utilize the connection concurrently. The method may further include causing a connection to be established at a connection time. In some example embodiments, the connection time is scheduled prior to an expiration of the connection time indication.

### TECHNOLOGICAL FIELD

Embodiments of the present invention relate generally to communications technology and, more particularly, relate to a method, apparatus, and computer program product for signaling load management.

### BACKGROUND

In the recent past, one or more networks have experienced breakdowns due to signaling load caused by independently acting applications operating on communications devices. In particular, the problem that led to the network breakdown was not solely based on exceeding a maximum data load on a core network, but instead it was a large number of network connections that were established for example, for the purpose of status updates generated by applications on the communication devices that caused a plurality of signaling requests. The signaling load, when analyzed in sum, resulted in an overload of the one or more network nodes in many of the documented network breakdowns. In some examples, the network has no possibility to coordinate those applications, since the applications are usually downloaded and installed individually by a user and generate status request that are not controlled by the network.

Additionally, not only does the increased signaling plague the core networks, but the increased signaling also results in an increased strain on a battery, for example a reduction in battery life, that is powering the communication device. The establishment of a radio connection is for a communication device is a very power intensive task. For example, the communication device may be operating one or more applications in the background and each of those applications may be loading status updates, which in turn generates one or more signaling requests. The one or more applications may act independently of each other and are usually written by different application companies. Such uncoordinated behavior results in constant activation and deactivation of a communications connection, which in turn, for example, overloads the network and drains the battery.

### BRIEF SUMMARY

A method, apparatus and computer program product are therefore provided according to an example embodiment of the present invention to enable the bundling of one or more connection requests in order to reduce overall signaling from a communication device. In some example embodiments, an application may provide a connection request that defines a connection time window. The method, apparatus and computer program product may therefore, in some examples, cause the connection to be established within the time window such that the connection is established concurrently with a scheduled network connection, bundled with other application requests, or the like. In some example embodiments, the connection may be established such that one or more applications may utilize the established connection in parallel. For example, the one or more applications do not necessarily establish their own radio connection, but schedule dependent, several network requests from the one or more applications may be bundled together on a single radio connection.

Alternatively or additionally, in some example embodiments, a connection may be scheduled at a later time based on the connection time window. In such cases the application includes in its request an indication as to whether the application has requested the earliest or latest possible connection. The earliest connection, for example, enables the freshest data to be provided to the application and ultimately to the user, the latest connection, for example, prevents the application server to suffer an overload. Alternatively or additionally, the connection time window may indicate a request for an immediate connection.

In some example embodiments, a method is provided that comprises receiving a connection request from an application. In some example embodiments, the connection request defines a connection time indication. The method of this embodiment may also include causing a connection to be established at a connection time.

In further example embodiments, an apparatus is provided that includes at least one processor and at least one memory including computer program code with the at least one memory and the computer program code being configured, with the at least one processor, to cause the apparatus to at least receive a connection request from an application. In some example embodiments, the connection request defines a connection time indication. The at least one memory and computer program code may also be configured to, with the at least one processor, cause the apparatus to cause a connection to be established at a connection time.

In yet further example embodiments, a computer program product may be provided that includes at least one non-transitory computer-readable storage medium having computer-readable program instructions stored therein with the computer-readable program instructions including program instructions configured to receive a connection request from an application. In some example embodiments, the connection request defines a connection time indication. The computer-readable program instructions may also include program instructions configured to cause a connection to be established at a connection time.

In yet further example embodiments, an apparatus is provided that includes means for receiving a connection request from an application. In some example embodiments, the connection request defines a connection time indication. The apparatus of this embodiment may also include means for causing a connection to be established at a connection time.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is an example block diagram of an example computing system for practicing embodiments of an example signaling management system in accordance with some example embodiments of the present invention;

FIG. 2 illustrates a block diagram of a mobile terminal representative of some example embodiments of the present invention; and

FIG. 3 is an example flowchart illustrating a method of signaling management performed in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

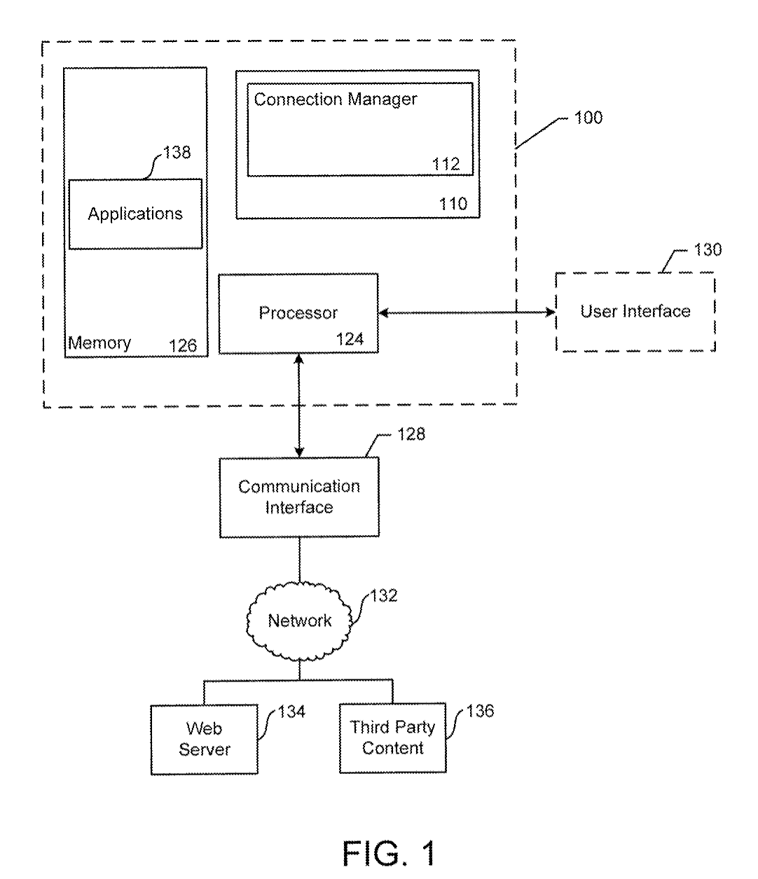

FIG. 1 is an example block diagram of an example computing system for practicing embodiments of an example signaling management system 110 in accordance with example embodiments of the invention. In particular the signaling management system 110 may be configured to cause a connection to be established in response to a connection request by an application, such that the connection is established during a scheduled network connection, bundled with other connection requests received from other applications, or the like.

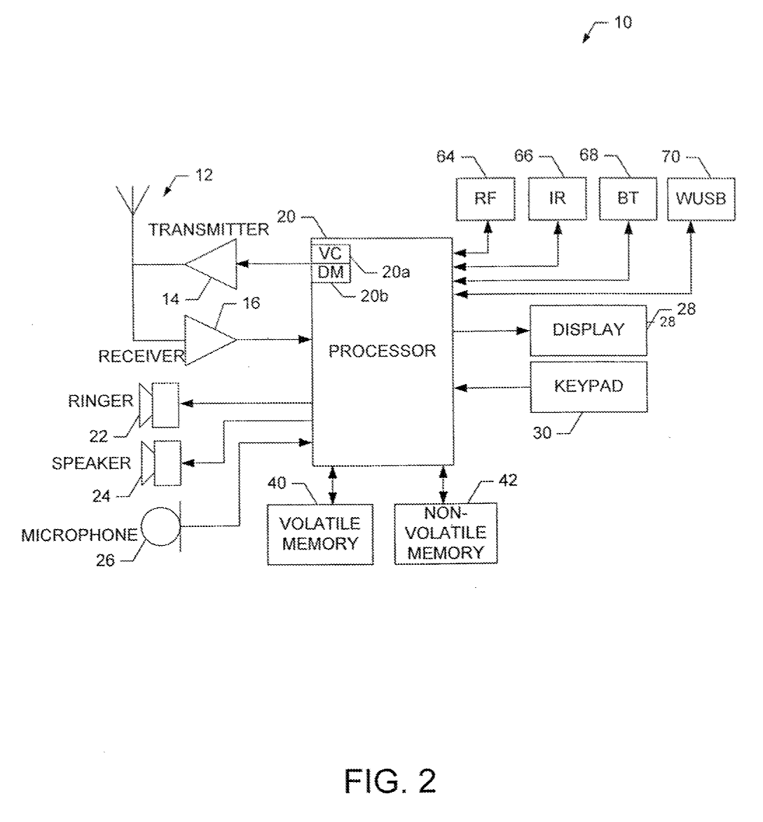

FIG. 1 shows a system 100 that may be utilized to implement a signaling management system 110. Note that one or more general purpose or special purpose computing systems may be used to implement the signaling management system 110, such as but not limited to the mobile terminal 10 of FIG. 2. In addition, the system 100 may comprise one or more distinct computing systems and may span distributed locations. Furthermore, each block shown may represent one or more such blocks as appropriate to a specific embodiment or may be combined with other blocks. For example, in some embodiments the system 100 may contain the connection manager 112. In other example embodiments, the connection manager may be configured to operate on separate connected systems (for example a mobile terminal and a remote server, multiple remote servers and/or the like). For example, the connection manager 112 may be configured to operate on a communication device, such as mobile terminal 10 of FIG. 2. In some example embodiments, the connection manager 112 may also be embodied by a modem, an application manager, an operating system or the like. Also, the signaling management system 110 may be implemented in software, hardware, firmware, or in some combination to achieve the capabilities described herein. As such, the signaling management system 110, the connection manager 112 and/or the processor 124 may reside in single chip or a software unit.

The example connection manager 112 in some example embodiments is configured to enable the bundling of one or more connection requests received from one or more applications in order to reduce signaling by a communication device, such as the mobile terminal 10. In some example embodiments, an application may provide the connection manager 112 with a connection request that defines a connection time window. The connection time window may be defined with a priority value, for example in an instance in which an urgent request is received. Alternatively or additionally, applications requesting an earliest or latest scheduling may be assigned different priorities.

In some example embodiments, the connection manager 112 may also be configured to determine whether a connection request is a single connection request or is a connection request that is configured to be recurring within the connection time window. For example, the connection manager 112 may be configured to cause connections automatically in accordance with an application's connections requests as long as the application is running or unless the application indicates that no further automatic status updates are requested. For example, the application may send a communication request for each status update, but it may also send one request and then may wait for the communication manager to process the request incoming data. This way, for example, battery power is preserved, because the application is configured to transmit fewer connection requests and as such resides in idle mode and waits for the incoming data.

The method, apparatus and computer program product may therefore, in some examples, cause the connection to a remote server, a network, the Internet or the like to be established within the connection time window that was defined in the connection request. The connection manager 112 may cause the connection to occur such that the connection is established during a previously scheduled network connection, bundled with other application requests, during a next connection or the like. In some example embodiments, the connection may be established such that one or more applications may utilize an established connection concurrently with other services, such as other applications operating on the device. For example, multiple applications may use the same connection without causing the connection to be opened and closed separately for each of the applications.

While the system 100 may be employed, for example, by a mobile terminal and/or a stand-alone system (for example, another communication device), it should be noted that the components, devices or elements described below may not be mandatory and thus some may be omitted in certain embodiments. Additionally, some embodiments may include further or different components, devices or elements beyond those shown and described herein.

In some example embodiments, system 100 comprises a computer memory (“memory”) 126, one or more processors 124 (for example processing circuitry) and a communications interface 128. The signaling management system 110 is shown residing in memory 126. In other embodiments, some portion of the contents, some or all of the components of the signaling management system 110 may be stored on and/or transmitted over other computer-readable media. The components of the signaling management system 110 preferably execute on one or more processors 124. The modules may be implemented by, embodied by and/or configured to execute on the processor 124. Other applications 138 (for example, an administrative interface, a Web server, other executable code and/or the like) and potentially other data repositories also reside in the memory 126, and preferably execute on processor 124. Of note, one or more of the components in FIG. 1 may not be present in any specific implementation.

In a typical embodiment, as described above, the signaling management system 110 may include a connection manager 112. The signaling management system 110 may interact via the network 132 via a communications interface 128 with web server 134 and/or with third-party content 136. The network 132 may be any combination of media (for example, twisted pair, coaxial, fiber optic, radio frequency), hardware (for example, routers, switches, repeaters, transceivers), and protocols (for example, TCP/IP, UDP, Ethernet, Wi-Fi, WiMAX) that facilitate communication between remotely situated humans and/or devices. In this regard, the communications interface 128 may be capable of operating with one or more air interface standards, communication protocols, modulation types, access types, and/or the like. More particularly, the system 100, the communications interface 128 or the like may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The system 100 may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

In an example embodiment, components/modules of the signaling management system 110 may be implemented using standard programming techniques. For example, the signaling management system 110 may be implemented as a “native” executable running on the processor 124, along with one or more static or dynamic libraries. In other embodiments, the signaling management system 110 may be implemented as instructions processed by a virtual machine that executes as one of the applications 138. In general, a range of programming languages known in the art may be employed for implementing such example embodiments, including representative implementations of various programming language paradigms, including but not limited to, object-oriented (for example, Java, C++, C#, Visual Basic.NET, Smalltalk, and the like), functional (for example, ML, Lisp, Scheme, and the like), procedural (for example, C, OpenCL C, OpenGL shading language, Pascal, Ada, Modula, and the like), scripting (for example, Perl, Ruby, Python, JavaScript, VBScript, and the like), and declarative (for example, SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the signaling management system 110, can be made available by standard mechanisms such as through C, C++, C#, and Java APIs; libraries for accessing files, databases, or other data repositories; through languages such as XML; or through Web servers, FTP servers, or other types of servers providing access to stored data. A data store may also be included and it may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, AJAX, and the like). Other variations are possible. Also, other functionality could be provided by each component/module, or existing functionality could be distributed amongst the components/modules in different ways, yet still achieve the functions described herein. The application may in some configuration be native to the device or downloaded later during the lifetime of the device. Furthermore, in some embodiments, some or all of the components of the signaling management system 110 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (for example, as executable or other machine-readable software instructions or structured data) on a computer-readable medium (for example, as a hard disk; a memory; a computer network or cellular wireless network or other data transmission medium; or a portable media article to be read by an appropriate drive or via an appropriate connection, such as a memory card or flash memory device) so as to enable or configure the computer-readable medium and/or one or more associated computing systems or devices to execute or otherwise use or provide the contents to perform at least some of the described techniques. Some or all of the system components and data structures may also be stored as data signals (for example, by being encoded as part of a carrier wave or included as part of an analog or digital propagated signal) on a variety of computer-readable transmission mediums, which are then transmitted, including across wireless-based and wired/cable-based mediums, and may take a variety of forms (for example, as part of a single or multiplexed analog signal, or as multiple discrete digital packets or frames). Such computer program products may also take other forms in other embodiments. Accordingly, embodiments of this disclosure may be practiced with other computer system configurations.

The system 100 may be embodied as and/or implemented such as, for example, by a desktop computer, laptop computer, mobile terminal, mobile computer, mobile phone, smartphone, mobile communication device, user equipment, tablet computing device, pad, game device, digital camera/camcorder, audio/video player, television device, radio receiver, tablet, digital video recorder, positioning device, wrist watch, portable digital assistant (PDA), fixed transceiver device (for example, attached to traffic lights, energy meters, light bulbs, and/or the like), a chipset, an apparatus comprising a chipset, any combination thereof, and/or the like.

In some example embodiments, the applications 138, such as for example social media applications, news feeds, banking programs, messaging applications and or the like, may request frequent status updates, such as via connection requests that are provided to the connection manager 112. The status update requests may be caused by one or more applications that may fall into a number of categories, such as but not limited to, applications that would request a maximize connectivity (for example an application that request constant or near constant connectivity) to operate correctly and applications that request partial connectivity so as to not overload the network 132, a web server 134, a third party server, such as third party content 136 and/or the like, and are configured to operate correctly based on the limited connectivity. For example a messaging application that only provides updates every ten minutes would be less useful than a messaging application that updates and/or checks for messages every fifteen seconds, whereas a news application may update hourly or upon user request and still may be considered to be operating correctly. Therefore, in some examples and as described herein, the connection manager 112 is configured to manage the connectivity requests for each of the applications 138, such that the maximum connectivity applications and the minimum or reduced connectivity applications may be bundled with other network connection requests to enable a reduced signaling in the system 100.

In some example embodiments, the connection manager 112 may receive a connection request from the one or more applications 138. In some examples, the connection request may be directed at the Hypertext Transfer Protocol (HTTP) stack, an Internet browser or the like. For example, applications, such as social media applications, may be configured to utilize the HTTP stack for connectivity and therefore may operate independently of a browser; however other applications may interact through the web browser. As such, the connection request may comprise a request defined by QT mobility 1.0 entitled bearer management, which is hereby incorporated by reference herein.

In some examples, a bearer management application programming interface (API) is configured to control a connectivity state. The network bearer management API is configured to enable a communication device, via an operating system or radio modem chip software, to manage one or more network interfaces via a set of configurations. For example, an application desiring connectivity makes a call to the network controlling entity via the API. Each configuration describes a set of parameters which instruct the system how a particular network interface is started. One example includes an Ethernet configuration that links a network card to a DHCP server. Another example may include a Wireless local area network (LAN) configuration which may comprise of hardware details such as the WLAN card address, WLAN access point details (for example Extended Service Set Identification (ESSID), encryption details) and user specific information (for example username and password). Once the network interface is configured and started according to the configuration, multiple applications are free to use this link layer connection/session for their own socket operations.

Other connection requests may be defined based upon the connection manager 112 and/or an operating system and/or the like. In some example embodiments, the connection request may be defined based on a connection request defined by operating system and in further examples may be backward compatible.

In some example embodiments, the connection request provided to the connection manager 112 may include one or more fields indicating a connection time indication and/or a connection type. The connection time may define the duration, such as in seconds that indicates a connection time interval before the expiration of which, the application has requested a connection. The connection type may include a minimum value (for example, “earliest”) or a maximum value (for example, “latest”). The minimum value may indicate that the connection time represents the longest time the application would wait in between connection requests. For example, the application may wish to have the first connection possible so to have the freshest information. The maximum value may indicate that the connection time represents the longest time the application is configured to wait before a connection is caused. For example, the application may wish the latest possible connection, so not to overload the application server that answers the

In some example embodiments, the connection manager 112 may be configured to determine, such as via the processor 124, that an urgent connection request has been received. In an instance in which an urgent connection request is received, the connection manager 112 may be configured to cause a connection to be established. For example, the connection manager 112 may not wait to bundle the urgent connection request with a connection request occurring in the future. In some examples, an urgent connection request may be indicated by a value, such as zero, in the connection time indication field of a connection request. Alternatively or additionally, the connection manager 112 may detect an empty or unpopulated connection time indication field in a connection request; in such cases the connection manager may process the connection request as if it were an urgent request.

Alternatively or additionally, the connection request may indicate to the connection manager 112, that the connection time indication is flexible. A flexible condition may indicate that a connection time indication may be a long period, for example 5 days, or may provide the connection manager 112 with flexibility regarding the timing of a connection, for example at a next available connection, when the battery is above a certain level, at a time of low activity, a user is operating on a home network, a WiFi connection is enabled and/or the like. For example, status updates may be performed in an instance a battery level is above 75%.

Alternatively or additionally, in some example embodiments, requests for connectivity may also be treated differently depending on available connectivity (for example, roaming, WiFi, home network). For example, the user may configure the device so that connection requests are rejected when roaming, except if time window is zero, such as a direct user request.

In operation and according to some example embodiments, once an application, such as application 138, has made a request, the application may continue to operate under normal operating conditions according to its behavior, for example the application will not change its operation while waiting for an indication of a connection from the connection manager 112. In some examples, the request is an asynchronous, e.g. non-blocking network request. In some example embodiments, the application may have specified, in the connection request, code that should be executed in an instance in which the connection manager provides an indication of a connection. For example, from the applications point of view the connection request handling does not affect the operation of the application, but simply adapts the connection time to be more efficient for the system 100. Alternatively or additionally, the connection manager 112 may utilize HTML5 features, such as WebSockets, alternative APIs, such as a bearer management API, AJAX calls and/or any other network calls generated by one or more applications 138.

After receiving the connection request and in some example embodiments, the connection manager 112 may be configured to determine a time (for example a connection time) to establish a connection for the requesting applications. For example, the connection manager 112 may be configured to determine other reoccurring requests for other applications and may then bundle the multiple connection requests. For example, the connection manager 112 may determine an optimal time at which it will cause a connection to be activated, such as by the communication interface 128. At the time in which a connection is activated, the connection manager 112, the processor 124 or the like may then be configured to start processing received connection requests. In other words, once a connection is established, the connection requests may be processed in sequence, based on priority or the like, such that a plurality of connection requests may be processed in an instance in which a connection is available, thereby, for example, reducing signal load and battery by not causing multiple connections to be established.

By way of further example, an application that sent a connection request with a five minute connection time indication and a max connection type may be bundled with an application that has a connection request that indicates a connection is needed every four minutes. In an instance in which multiple applications are operating on the system 100, the connection manager 112 may bundle, align or otherwise cause a connection to be established, such as via the communication interface 128, when multiple of the application can utilize the connection concurrently. In an instance in which there are multiple operating applications or in an instance in which there is only a single application operating, the connection manager 112 may combine a connection request from an application with another scheduled network request. For example, a social media status update may be bundled with a setting to check the mail for an electronic mail client every fifteen minutes. Alternatively or additionally, the connection manager 112 may cause a connection to be delayed until a predefined number of connection requests have been received, a battery level is above a threshold, an environmental or contextual condition has been met or the like.

Once the one or more connections have been scheduled by the connection manager 112, the connection manager 112, such as with the processor 124, the communication interface 128 or the like, may cause the connection to be established. The connection may enable the one or more applications and/or the one or more network requests to be scheduled such that the multiple applications and/or the multiple connection requests utilize the connection concurrently.

In some example embodiments, a signaling management system 110 may be embodied as a mobile terminal, such as that illustrated in FIG. 2. In this regard, FIG. 2 illustrates a block diagram of a mobile terminal 10 representative of one embodiment of a signaling management system 110. It should be understood, however, that the mobile terminal 10 illustrated and hereinafter described is merely illustrative of one type of system (for example, signaling management system 110) that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, tablets, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Bluetooth™ (BT), Ultra-wideband (UWB), Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols such as LTE Advanced and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) or software defined radio 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). The mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to low power/energy or ultra-low power/energy Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

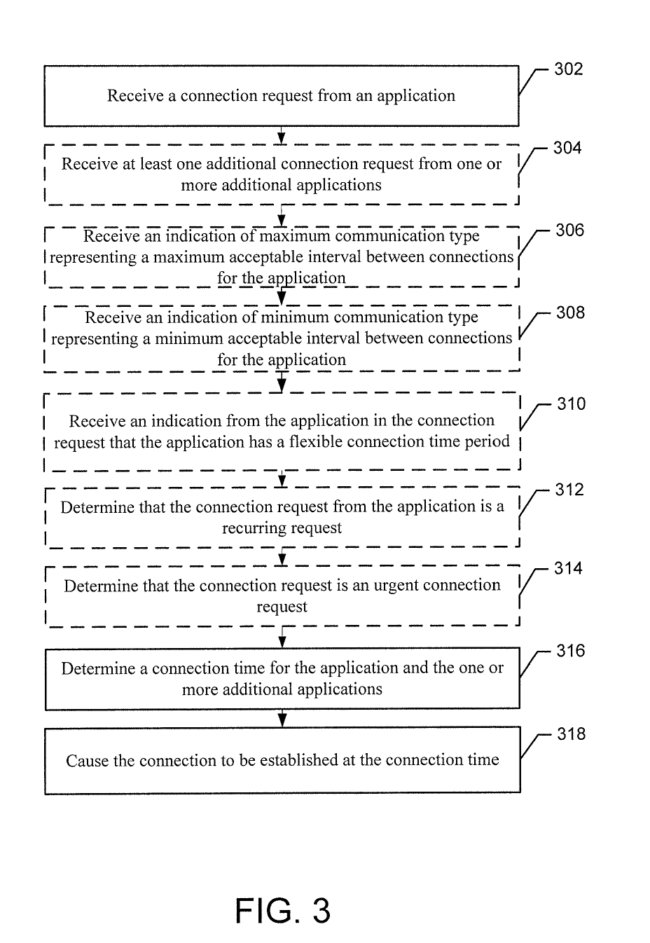

FIG. 3 illustrates an example flowchart of the example operations performed by a method, apparatus and computer program product in accordance with an embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described herein may be embodied by computer program instructions. In this regard, the computer program instructions that embodies the procedures described herein may be stored by one or more memory devices (for example, memory 126, volatile memory 40, or non-volatile memory 42) of a mobile terminal, server, or other computing device (for example, the signaling management system 110, the mobile terminal 10) and executed by a processor (for example, the processor 124 or processor 20) in the computing device. As will be appreciated, any such computer program instructions may be loaded onto a computer or other programmable apparatus (for example, hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 3, when executed, convert a computer or processing circuitry into a particular machine configured to perform an example embodiment of the present invention. Accordingly, the operations of FIG. 3 define an algorithm for configuring a computer or processing to perform an example embodiment. In some cases, a general purpose computer may be provided with an instance of the processor which performs the algorithms of FIG. 3 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 3 is an example flowchart illustrating a method of hosting the buffer creation and clearance performed in accordance with an embodiment of the present invention. As shown in operation 302, an apparatus may include means, such as the connection manager 112, the processor 124 or the like for receiving a connection request from an application. As shown in operation 304, an apparatus may include means, such as the connection manager 112, the processor 124 or the like for receiving at least one additional connection request from one or more additional applications. In some example embodiments, the connection request may include a connection time indication and a connection type. For example, the connection time indication is the requested time interval in which a connection for the application is to be scheduled. In some example embodiments, the connection request is provided in an extension to an application programming interface, such as a bearer management API, configured to request connectivity. However the connection request may take other forms such as but not limited to a JavaScript interpreter inside a browser, a call to a native HTTP stack in a mobile device, a call to a widget runtime engine or the like.

The connection type may include an indication of a maximum connection type or a minimum connection type. As shown in operation 306, an apparatus may include means, such as the connection manager 112, the processor 124 or the like for receiving an indication of maximum connection type representing a maximum acceptable interval between connections for the application. As shown in operation 308, an apparatus may include means, such as the connection manager 112, the processor 124 or the like for receiving an indication of minimum connection type representing a minimum acceptable interval between connections for the application. In an instance in which a connection type is indicated in the connection request, the connection manager 112, the processor 124 or the like may cause the connection to be scheduled within the maximum acceptable interval or the minimum acceptable interval.

In some examples, the received connection request may indicate a case, such as a flexible time period, recurring request or an urgent request. For example, as shown in operation 310, an apparatus may include means, such as the connection manager 112, the processor 124 or the like for receiving an indication from the application in the connection request that the application has a flexible connection time indication. By way of further example, as shown in operation 312, an apparatus may include means, such as the connection manager 112, the processor 124 or the like for determining that the connection request from the application is a recurring request. By way of yet further example, as shown in operation 314, an apparatus may include means, such as the connection manager 112, the processor 124 or the like for determining that the connection request is an urgent connection request.

As shown in operation 316, an apparatus may include means, such as the connection manager 112, the processor 124 or the like for determining a connection time for the application and the one or more additional applications. In some example embodiments, the connection time may be determined based on the ability for one or more applications and/or network requests to concurrently utilize the connection. In some cases, the bundling, grouping, synchronizing or the like of the applications is accomplished, such as by the communication manager 112, the processor 124 and/or the like, based on the one or more received connection requests and the various communication time periods and types provided with respect to operations 302-314. As shown in operation 318, an apparatus may include means, such as the connection manager 112, the processor 124, the communication interface 128 or the like for causing the connection to be established at the connection time.

The systems and methods as described herein result in, for example, a reduced signaling load. Additionally, a communication device, such as a mobile terminal, may be prioritized on a network based on its ability to operate using a reduced signaling load.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-44. (canceled)

45. A method comprising:
receiving a connection request from an application, wherein the connection request defines a connection time indication;
determining that the connection request from the application is a recurring request;
establishing a connection request bundle, the connection request bundle established based on the connection time indication for the connection request and connection time indications for one or more other recurring connection requests received from one or more additional applications; and
causing, using a processor, one or more connection requests to be processed to utilize a connection in an instance in which the connection satisfies the connection time indication for each of the connection request and the one or more other recurring connection requests.

46. The method according to claim 45, wherein the connection time indication is set based on a length of time before a next connection is requested, and wherein the connection time is scheduled prior to an expiration of any of the connection time indications.

47. The method according to claim 45, further comprising:
receiving at least one additional connection request from the one or more additional applications; and
determining an updated connection time for the application and the one or more additional applications, wherein the updated connection time is configured to enable the application and the one or more additional applications to utilize the connection concurrently.

48. The method according to claim 45, further comprising:
receiving an indication of a maximum connection type representing a maximum acceptable interval between connections for the application; and
causing an updated connection time to be selected for the application based on the maximum connection type.

49. The method according to claim 45, further comprising:
receiving an indication of a minimum connection type representing a minimum acceptable interval between connections for the application; and
causing an updated connection time to be selected for the application based on the minimum connection type.

50. The method according to claim 45, wherein the connection request is provided in an extension to an application programming interface configured to request connectivity.

51. The method according to claim 50, wherein the application programming interface is a bearer management application programming interface.

52. The method according to claim 45, further comprising:
receiving an indication from the application in the connection request that the application has a flexible connection time indication; and
causing the connection request to be scheduled at a next available connection time where the one or more additional applications have been scheduled to utilize the connection concurrently.

53. The method according to claim 45, further comprising:
determining that the connection request is an urgent connection request; and
causing a connection to be established.

54. The apparatus comprising:
at least one processor; and
at least one memory including computer program code, the at least one memory and the computer program code configured to, with the at least one processor, cause the apparatus to at least:
receive a connection request from an application, wherein the connection request defines a connection time indication;
determine that the connection request from the application is a recurring request;
establish a connection request bundle, the connection request bundle established based on the connection time indication for the connection request and connection time indications for one or more other recurring connection requests received from one or more additional applications; and
cause one or more connection requests in the connection request bundle to be processed to utilize a connection in an instance in which the connection satisfies the connection time indication for each of the connection request and the one or more other recurring connection requests.

55. The apparatus according to claim 54, wherein the at least one memory including the computer program code is further configured to, with the at least one processor, cause the apparatus to:
receive at least one additional connection request from the one or more additional applications; and
determine an updated connection time for the application and the one or more additional applications, wherein the updated connection time is configured to enable the application and the one or more additional applications to utilize the connection concurrently.

56. The apparatus according to claim 54, wherein the at least one memory including the computer program code is further configured to, with the at least one processor, cause the apparatus to:
receive an indication of a maximum connection type representing a maximum acceptable interval between connections for the application; and
cause an updated connection time to be selected for the application based on the maximum connection type.

57. The apparatus according to claim 54 wherein the at least one memory including the computer program code is further configured to, with the at least one processor, cause the apparatus to:
receive an indication of a minimum connection type representing a minimum acceptable interval between connections for the application; and
cause an updated connection time to be selected for the application based on the minimum connection type.

58. The apparatus according to claim 54, wherein the at least one memory including the computer program code is further configured to, with the at least one processor, cause the apparatus to:
receive an indication from the application in the connection request that the application has a flexible connection time indication; and
cause the connection request to be scheduled at a next available connection time where the one or more additional applications have been scheduled to utilize the connection concurrently.

59. The apparatus according to claim 54, wherein the at least one memory including the computer program code is further configured to, with the at least one processor, cause the apparatus to:
determine that the connection request is an urgent connection request; and
cause a connection to be established.

60. A computer program product comprising:
at least one computer readable non-transitory memory medium having program code stored thereon, the program code which when executed by an apparatus cause the apparatus at least to:
receive a connection request from an application, wherein the connection request defines a connection time indication;
determine that the connection request from the application is a recurring request;
establish a connection request bundle, the connection request bundle established based on the connection time indication for the connection request and connection time indications for one or more other recurring connection requests received from one or more additional applications; and
cause one or more connection requests in the connection request bundle to be processed to utilize a connection in an instance in which the connection satisfies the connection time indication for each of the connection request and the one or more other recurring connection requests.

61. A computer program product according to claim 60, further comprising program code instructions configured to:
receive at least one additional connection request from the one or more additional applications; and
determine an updated connection time for the application and the one or more additional applications, wherein the updated connection time is configured to enable the application and the one or more additional applications to utilize the connection concurrently.

62. A computer program product according to claim 60, further comprising program code instructions configured to:
receive an indication of a maximum connection type representing a maximum acceptable interval between connections for the application; and
cause an updated connection time to be selected for the application based on the maximum connection type.

63. A computer program product according to claim 60, further comprising program code instructions configured to:
receive an indication of a minimum connection type representing a minimum acceptable interval between connections for the application; and
cause an updated connection time to be selected for the application based on the minimum connection type.

64. A computer program product according to claim 60, further comprising program code instructions configured to:
receive an indication from the application in the connection request that the application has a flexible connection time indication; and
cause the connection request to be scheduled at a next available connection time where the one or more applications have been scheduled to utilize the connection concurrently.
